(19) United States
(12) Patent Application Publication
(10) Pub. No.: US 2009/0061102 A1
(43) Pub. Date: Mar. 5, 2009

(54) DUST CONTROL COMPOSITIONS AND METHOD OF INHIBITING DUST

(75) Inventors: Kenneth D. Burnside, Fort Myers, FL (US); John C. Cranfill, Pewee Valley, KY (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: AKJ INDUSTRIES, Fort Meyers, FL (US)

(21) Appl. No.: 11/849,000

(22) Filed: Aug. 31, 2007

(51) Int. Cl. C09K 3/22; B05D 1/02; B05D 1/30

(52) U.S. Cl. 427/427.1; 252/88.1; 427/445

(57) ABSTRACT

A method for controlling dust on a surface comprising forming admixture of xanthan gum in water, calcium chloride, magnesium chloride, glycerol or glycerin in an amount effective to control dust; and applying the admixture to a surface.

### FIELD OF THE INVENTION

The present invention relates to dust control compositions. More specifically, the invention is directed to dust-inhibiting concentrates and other solutions containing suspended and/or soluble xanthan gum.

### BACKGROUND

Halide brines, comprising one or more dissolved or suspended salts in water, usually halide salts, especially chloride salts, particularly calcium chloride, magnesium chloride and other alkali metal and alkaline earth metal salts, are used extensively for inhibiting dust on a variety of surfaces including such uses as dust control of roadways, paved areas, bridges and the like as well as for inhibiting dust on surfaces of bulk materials, such as coal, coke, limestone and minerals. They are also used for dust control, especially during dry weather during the handling and transportation of dust-producing bulk materials, such as coal, coke and limestone.

Aqueous solutions of these halides are known to corrode metals and cause scaling or surface damage to concrete. For example, heavy use of road deicers can result in serious damage to steel, particularly autos and other vehicles, as well as rapid deterioration of steel reinforcing rods in poured concrete roadways and bridges. The halides used for dust control of bulk materials such as coal or other minerals often cause corrosive deterioration of the materials-handling equipment, rail cars and other container carriers.

The prior art uses costly latex solutions, petroleum resin, and polyvinyl alcohol (US 2007/0135561 A1) for dust control on road surfaces under construction and coal surfaces being transported by rail car.

In accordance with the present invention, it has been found that a solution of xanthan gum will resist absorption into pores of coal and other mineral surfaces, including soil, so that after drying into a continuous or discontinuous film, the xanthan gum will provide later dust control, as well as exhibiting dust control and anti-corrosion properties upon later wetting with water.

### SUMMARY

The present invention is directed to a method of inhibiting dust on a surface by applying an aqueous solution of dissolved xanthan gum, optionally containing glycerin, a glycol, calcium chloride or magnesium chloride for freeze protection.

In one embodiment, there is disclosed a method of inhibiting dust by applying an aqueous composition from a diluted concentrate wherein the concentrate composition contains about 10 wt. % to about 50 wt. % preferably about 20 wt. % to about 40 wt. % xanthan gum, preferably in slurry form in water or an oil or hydrocarbon fluidizing agent, such as mineral oil, a glycol, or glycerin (in emulsion or slurry form), and the diluted concentrate contains about 0.01% to about 10% xanthan gum; preferably about 0.01 wt. % to about 5.0 wt. %, more preferably about 0.05 wt. % to about 3.0 wt. % xanthan gum dissolved in water. The concentrate composition may have as little as about 0.5 wt. % dissolved xanthan gum in water for later dilution with water in the field (at the location of controlling dust) to provide a dust-control composition containing about 0.01 wt. % to about 3.0 wt. % xanthan gum; and about 97 wt. % to about 99.99 wt. % water. Optionally, the composition includes an anti-freeze agent (for winter use) such as a glycol, e.g., glycerin, calcium chloride, or magnesium chloride in an amount sufficient to prevent freezing under ambient conditions, e.g., about 10 wt. % to about 50 wt. %.

In a preferred method for applying the xanthan gum composition to a surface, the steps comprise: forming an admixture of xanthan gum solubilized in water; and applying the admixture to a surface at a rate effective for dust control. Preferably the solution comprises from 0.01 to about 5 wt. % xanthan gum, more preferably about 0.05 wt. % to about 2% by weight xanthan gum; and about 98 wt. % to about 99.95 wt. % water.

In the preferred embodiment, the admixture is applied to coal, coke and other minerals in rail cars; to mineral floors of a mine; and to road surfaces for controlling dust. The rate of application during this dust control embodiment is from about 0.001 to about 5 gallons per square yard, preferably 0.1 to about 1.5 gallons to 1 square yard. The admixture can be applied, for example, by sprinkling or using a spray nozzle.

During one preferred method described herein containing calcium chloride in an amount of about 28 wt. % of the composition, the rate of corrosion of steel and aluminum by the admixture is reduced by at least 70%, as compared to the rate of corrosion of steel by a halide brine of the same concentration but without the xanthan gum. Surprisingly, the xanthan gum inhibits corrosion of aluminum and steel surfaces that it is applied onto at a concentration of xanthan gum of only about 0.025% by weight of the dust control composition.

In accordance with important aspects of the xanthan gum-containing compositions and methods described herein, it has been found that the aqueous xanthan gum compositions described herein 1) resist evaporation about four times longer than water alone; 2) absorb moisture from ambient humidity and thereby provide long lasting adherence of small dust particles to larger particles, e.g., on coal dust during and after transportation, and in mineral mining operations and road dust control; and 3) over repeated applications, the amount of xanthan gum that adheres smaller particles to larger particles will build up over time to provide more effective and longer lasting dust control.

In a preferred glycerin-free composition for use on road surfaces, the composition comprises from 0.01 to 2% xanthan gum and about 98 to about 99.99% water.

In another embodiment, the dust control composition can be provided as a concentrate, for subsequent dilution with water; comprising about 90 wt. % to about 99.5 wt. % water; or about 0.5 wt. % to about 10 wt. % xanthan gum, based on the total weight of xanthan gum and water, in mineral oil.

In one method of applying xanthan gum for dust control the steps comprise: forming an admixture of xanthan gum dispersed in water in an amount of xanthan gum that is effective to control dust and, optionally including glycerin and/or a glycol to prevent freezing during winter use; and applying the admixture to surfaces of dust-producing materials. This method can be used to treat all of the dust-producing materials or to bind/control dust on the outer surface, i.e. rails cars and storage piles.

### DETAILED DESCRIPTION

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The surprising discovery in the method of this invention is the effect of improved and long-lasting dust control and corrosion-inhibiting properties resulting from the presence of xanthan gum applied to various surfaces. Any surface exposed to dust-producing conditions can benefit from the method described herein.

Typical surfaces that require treatment for exposure to dust-yielding conditions are mineral, e.g., coal mines, coal, coke or limestone being transported by rail car, roadways, pavements, paved and unpaved open areas such as stock yards, bridges and the like. Coal, coke, limestone and other minerals may also produce dust that must be contained so as to limit pollution of the environment. Automobiles, metal rods used in construction of roads and bridges and the steel and metal components associated with the railways and other materials-handling equipment benefit from the corrosion-inhibiting feature of xanthan gum during treatments for dust control.

In accordance with a preferred embodiment of the methods described herein, the solution of xanthan gum in water is used to bind dust particles to larger particles, particularly on mineral, e.g., coal, mine floors and on coal during transport via uncovered rail cars. On mineral mine floors and as a surface covering for coal and other dust-producing minerals being transported in uncovered rail cars, the xanthan gum preferably has a concentration of about 0.1 wt. % to about 2 wt. % to bind smaller mineral particles to larger mineral particles. The xanthan gum coating resists absorption of the solution into the pores of the larger mineral particles and the xanthan gum absorbs water from the atmosphere and resists water evaporation to maintain the binding capability of the xanthan gum for continued binding of smaller mineral particles to larger mineral particles, even during movement and settling during transport.

If repeated applications of the xanthan gum solution are needed, such as on a roadway surface during construction, the xanthan gum concentration increases with each application to maintain the soil surface damp for an unexpectedly long period of time, e.g., about four times or more as long as using water only. The xanthan gum compositions described herein can be applied as xanthan gum solubilized in water, or may be applied as a xanthan gum in water that is emulsified together with an oil, such as mineral oil. Alternatively, the composition can be provided as a slurry containing, for example, 30-50 wt. % xanthan gum solids in 50-70 wt. % mineral oil for later dilution with water and an emulsifying agent for use as an oil-in-xanthan gum-containing water emulsion.

The xanthan gum is solvent soluble in water and can be easily solubilized using standard mixing apparatus.

In the method of dust control, the admixture resulting from the blend of xanthan gum in aqueous solution is applied to a surface of the material requiring dust control. One preferred rate of application is from about 0.001 to 5.0 gallons of admixture per square yard of surface treated. Rates vary according to the surface receiving the application. With unpaved roads, for example, the rate of application can be adjusted within a preferred range of 0.1 to 1.5 gallon of blend to one square yard of road. Treatment rates of application for other surfaces are known in the art.

The admixture can be applied to the surfaces of roads, bridges or bulk substances carried in open containers by any of several methods known in the art. One preferred method is sprinkling of the admixture solution over the surface requiring freeze conditioning or dust control. Another preferred method is spraying the admixture by nozzles, preferably pressurized nozzles, so that the mechanical action of the spray provides complete coverage of the admixture into unpaved road surfaces, coal, coke, limestone, and the like. Other known methods can be used to apply the admixture.

What is claimed:

1. A method for controlling dust on a surface comprising:
forming an admixture of xanthan gum in water wherein the xanthan gum is present in an amount effective to inhibit dust movement from the surface; and
applying the admixture to the surface.

2. The method of claim 1 wherein the admixture is applied to the surface at the rate of from about 0.001 to about 5.0 gallon per square yard for controlling dust.

3. The method of claim 1 wherein the admixture is applied by sprinkling.

4. The method of claim 1 wherein the admixture is applied by spray nozzle.

5. The method of claim 1 wherein the rate of corrosion of steel by the admixture is reduced by at least 70 percent as compared to the rate of the corrosion of steel by the same concentration of a calcium chloride brine.

6. A method for applying a xanthan gum coating to a dusty surface of a dust-producing material dust control comprising the steps of:
forming an admixture of xanthan gum dispersed in water in an amount effective to inhibit movement of dust from a dusty surface; and
applying the admixture to the dusty surface of a dust-producing material.

7. A composition suitable for dust control, while limiting corrosion iron containing metal surfaces contacted by said composition, consisting essentially of an aqueous solution containing at least 0.01% by weight xanthan gum.

8. An aqueous concentrate composition, suitable for dust control upon dilution with water consisting essentially of water; and about 0.5 wt. % to about 10 wt. % xanthan gum.

9. The aqueous concentrate composition of claim 8, containing about 1 wt. % to about 5 wt. % xanthan gum.

10. A method for controlling dust on a surface with limited corrosion comprising:
forming an admixture of xanthan gum and about 10 wt % to about 50 wt. % glycerin in water wherein the xanthan gum is present in an amount effective to inhibit corrosion of a contacting metal selected from the group consisting of iron and aluminum; and
applying the admixture to a surface in an amount effective for dust control.

11. The method of claim 10, wherein the surface is a soil surface.

12. The method of claim 10, wherein the surface is a surface of coal particles.

13. The method of claim 10, wherein the surface is a mineral ore storage pile.

14. The method of claim 13, wherein the mineral ore is coal.

15. A method for maintaining small mineral ore particles adhered to larger mineral ore particles during transportation in open rail cars comprising applying a composition comprising a solution of 0.01 to about 10 wt. % xanthan gum in water to surfaces of at least a portion of said larger mineral ore particles to bind the smaller mineral ore particles to the larger mineral ore particles.

16. The method of claim 15, wherein the solution contains about 0.1 to about 5 wt % xanthan gum.

17. The method of claim 15, wherein the mineral ore is coal.
